(19) United States
(12) Patent Application Publication
(10) Pub. No.: US 2014/0267137 A1
(43) Pub. Date: Sep. 18, 2014

(54) PROXIMITY SENSING USING DRIVEN GROUND PLANE

(71) Applicant: SYNAPTICS INCORPORATED, Santa Clara, CA (US)

(72) Inventors: Derek Solven, San Jose, CA (US); Adam Schwartz, Redwood City, CA (US); Tracy Scott Dattalo, Santa Clara, CA (US)

(73) Assignee: Synaptics Incorporated, Santa Clara, CA (US)

(21) Appl. No.: 13/828,677

(22) Filed: Mar. 14, 2013

(51) Int. Cl. G06F 3/041

(52) U.S. Cl. CPC G06F 3/0418
USPC 345/174

(57) ABSTRACT

A method and apparatus for operating an input device having an array of capacitive sensor electrodes disposed on a substrate with a ground plane, and a proximity sensor electrode are disclosed herein. The input device includes a processing system configured to operate in an input mode and a proximity mode. When operating in the input mode, the processing system drives the ground plane to a grounding voltage and scans the array of capacitive sensor electrodes to detect input from an object in an active region of the input device. When operating in the proximity mode, the processing system drives a sensing signal on the ground plane, and optionally, one or more sensor electrodes of the array of capacitive sensor electrodes and receives a resulting signal from the proximity sensor electrode. The processing system generates an indication of an object presence in a second sensing region based on the resulting signal.

### FIELD OF INVENTION

Embodiments of the present invention relate to an input device, processing system, and method for proximity sensing utilizing capacitive touch sensors.

### BACKGROUND

Touch sensor devices (also commonly called touch pads or touch screen) is typically a sensitive surface that uses capacitive, resistive, inductive, optical, acoustic or other technology to determine the presence, location and or motion of one or more fingers, styli, and/or other objects. The touch sensor device, together with a finger or other object provides an input to the electronic system. For example, touch sensor devices are used as input devices for computers, such as notebook computers.

Touch sensor devices are also used in smaller devices, such as personal digital assistants (PDAs) and communication devices such as wireless telephones and text messaging devices. Increasingly, touch sensor devices are used in multimedia devices, such as CD, DVD, MP3, video or other media players. Many electronic devices include a user interface (UI) and an input device for interacting with the UI. A typical UI includes a screen for displaying graphical and/or textual elements. The increasing use of this type of UI has led to a rising demand for touch sensor devices as pointing devices. In these applications the touch sensor device can function as a cursor control device, selection device, scrolling device, character/handwriting input device, menu navigation device, gaming input device, button input device, keyboard and/or other input device.

One challenge in touch sensor device design is differentiating between deliberate input and incidental contact to the touch sensor device. This is particularly true for wireless communication devices, such as mobile phones. For example, when a user holds a mobile phone near their face to conduct a phone call, the touch sensor device might register input to the mobile phone if the user's face (e.g., cheek) contacts the touch sensor device. As such, when a user holds a mobile phone near their face to conduct a phone call, it may be desirable to deactivate the touch input support while the user is making a call.

Typically, an independent sensor (e.g. infrared sensor) is used for the purpose of detecting the proximity of the user to the sensing region and disabling or otherwise suppressing input in the sensing region of the input device. However, infrared sensors and their supporting circuitry increase the manufacturing costs and are limited to detecting objects in a pre-defined position relative to the infrared sensor. Further, a separate subsystem for the infrared sensor may take up additional space within the electronic system which already faces substantial space and size constraints.

Therefore, there is a need for an improved input device, processing system, and method for sensing an input object relative to a sensing region of a touch sensor device.

### SUMMARY OF THE INVENTION

An input device, processing system for an input device, and method for proximity sensing utilizing capacitive touch sensors are disclosed herein. In one embodiment, an input device includes a ground plane disposed on a first surface of a substrate, an array of capacitive sensor electrodes disposed within the ground plane on the first surface of the substrate and configured to sense input objects in a first sensing region, and a proximity sensor electrode configured to sense input objects in a second sensing region. The input device further includes a processing system communicatively coupled to the array of capacitive sensor electrodes, the proximity sensor electrode, and the ground plane, and configured to operate in a first mode and a second mode. The processing system is configured to operate in the first mode, which includes receiving a sensing resulting signal produced between a first set of sensor electrodes of the array of capacitive sensor electrodes and a second set of sensor electrodes of the array of capacitive sensor electrodes, and generating an indication of object presence in the first sensing region based on the sensing resulting signal. The processing system is further configured to operate in the second mode, including receiving a first resulting proximity signal produced between the proximity sensor electrode and the ground plane, and generating an indication of object presence in the second sensing region based on the first resulting proximity signal.

In another embodiment, a processing system for an input device includes sensor circuitry configured to be communicatively coupled to a proximity sensor electrode, a ground plane, and an array of capacitive sensor electrodes, wherein the ground plane and the array of capacitive sensor electrodes are disposed on a first surface of a substrate. The processing system further includes control logic configured to operate the input device in a first mode, which includes receiving a sensing resulting signal produced between a first set of sensor electrodes of the array of capacitive sensor electrodes and a second set of sensor electrodes of the array of capacitive sensor electrodes, and generating an indication of object presence in a sensing region based on the sensing resulting signal. The processing system further includes control logic configured to operate the input device in a second mode including receiving a first resulting proximity signal produced between the proximity sensor electrode and the ground plane, and generating an indication of object presence in a second sensing region based on the first resulting proximity signal.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of an exemplary input device, in accordance with embodiments of the invention.

FIG. 2 depicts a schematic diagram of sensing elements of an input device, according to one embodiment of the invention.

FIG. 3 depict a block diagram of an exemplary pattern of sensing elements disposed on a substrate, according to one embodiment of the invention.

FIG. 4 is a flow diagram illustrating a method for operating an input device in an input mode and a proximity mode, according to one embodiment of the invention.

FIG. 5 depicts a schematic side view of the sensor pattern of FIG. 3, according to one embodiment of the present invention.

To facilitate understanding, identical reference numerals have been used, where possible, to designate identical elements that are common to the figures. It is contemplated that elements disclosed in one embodiment may be beneficially utilized on other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

FIG. 1 is a block diagram of an exemplary input device 100, in accordance with embodiments of the present technology. In FIG. 1, the input device 100 is shown as a proximity sensor device (also often referred to as a “touchpad” or a “touch sensor device”) configured to sense input provided by one or more input objects 140 in a sensing region 120. Example input objects include fingers and styli, as shown in FIG. 1. The input device 100 may be configured to provide input to an electronic system 150. As used in this document, the term “electronic system” (or “electronic device”) broadly refers to any system capable of electronically processing information. Some non-limiting examples of electronic systems 150 include personal computers of all sizes and shapes, such as desktop computers, laptop computers, netbook computers, tablets, web browsers, e-book readers, and personal digital assistants (PDAs). Additional example electronic systems 150 include composite input devices, such as physical keyboards that include input device 100 and separate joysticks or key switches. Further example electronic systems 150 include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic system could be a host or a slave to the input device.

The input device 100 can be implemented as a physical part of the electronic system 150, or can be physically separate from the electronic system 150. As appropriate, the input device 100 may communicate with parts of the electronic system using any one or more of the following: buses, networks, and other wired or wireless interconnections. Examples include I²C, SPI, PS/2, Universal Serial Bus (USB), Bluetooth, RF, and IRDA.

Sensing region 120 encompasses any space above, around, in and/or near the input device 100 in which the input device 100 is able to detect user input (e.g., user input provided by one or more input objects 140). The sizes, shapes, and locations of particular sensing regions may vary widely from embodiment to embodiment. In some embodiments, the sensing region 120 extends from a surface of the input device 100 in one or more directions into space until signal-to-noise ratios prevent sufficiently accurate object detection. The distance to which this sensing region 120 extends in a particular direction, in various embodiments, may be on the order of less than a millimeter, millimeters, centimeters, or more, and may vary significantly with the type of sensing technology used and the accuracy desired. Thus, some embodiments sense input that comprises no contact with any surfaces of the input device 100, contact with an input surface (e.g., a touch surface) of the input device 100, contact with an input surface of the input device 100 coupled with some amount of applied force or pressure, and/or a combination thereof. In various embodiments, input surfaces may be provided by surfaces of casings within which the sensor electrodes reside, by face sheets applied over the sensor electrodes or any casings, etc. In some embodiments, the sensing region 120 has a rectangular shape when projected onto an input surface of the input device 100.

The input device 100 may utilize any combination of sensor components and sensing technologies to detect user input in the sensing region 120. The input device 100 comprises one or more sensing elements for detecting user input. As several non-limiting examples, the input device 100 may use capacitive, elastive, resistive, inductive, magnetic, acoustic, ultrasonic, and/or optical techniques. The input device 100 includes an array of sensing elements and a proximity sensor offset from the array of sensing components, as further described below.

Some implementations are configured to provide images that span one, two, three, or higher dimensional spaces. Some implementations are configured to provide projections of input along particular axes or planes.

In FIG. 1, the processing system 110 is shown as part of the input device 100. The processing system 110 is configured to operate the hardware of the input device 100 to detect input in the sensing region 120. The processing system 110 comprises parts of or all of one or more integrated circuits (ICs) and/or other circuitry components. (For example, a processing system for a mutual capacitance sensor device may comprise transmitter circuitry configured to transmit signals with transmitter sensor electrodes, and/or receiver circuitry configured to receive signals with receiver electrodes). In some embodiments, the processing system 110 also comprises electronically-readable instructions, such as firmware code, software code, and/or the like. In some embodiments, components composing the processing system 110 are located together, such as near sensing element(s) of the input device 100. In other embodiments, components of processing system 110 are physically separate with one or more components close to sensing element(s) of input device 100, and one or more components elsewhere. For example, the input device 100 may be a peripheral coupled to a desktop computer, and the processing system 110 may comprise software configured to run on a central processing unit of the desktop computer and one or more ICs (perhaps with associated firmware) separate from the central processing unit. As another example, the input device 100 may be physically integrated in a phone, and the processing system 110 may comprise circuits and firmware that are part of a main processor of the phone. In some embodiments, the processing system 110 is dedicated to implementing the input device 100. In other embodiments, the processing system 110 also performs other functions, such as operating display screens, driving haptic actuators, etc.

The processing system 110 may be implemented as a set of modules that handle different functions of the processing system 110. Each module may comprise circuitry that is a part of the processing system 110, firmware, software, or a combination thereof. In various embodiments, different combinations of modules may be used. Example modules include hardware operation modules for operating hardware such as sensor electrodes and display screens, data processing modules for processing data such as sensor signals and positional information, and reporting modules for reporting information. Further example modules include sensor operation modules configured to operate sensing element(s) to detect input, identification modules configured to identify gestures such as mode changing gestures, and mode changing modules for changing operation modes. One embodiment of the processing system 110 is described in greater detail in conjunction with FIG. 2.

In some embodiments, the processing system 110 responds to user input (or lack of user input) in the sensing region 120 directly by causing one or more actions. Example actions include changing operation modes, as well as GUI actions such as cursor movement, selection, menu navigation, and other functions. In some embodiments, the processing system 110 provides information about the user input (or lack of user input) to some part of the electronic system (e.g., to a central processing system of the electronic system that is separate from the processing system 110, if such a separate central processing system exists). In some embodiments, some part of the electronic system processes information received from the processing system 110 to act on user input, such as to facilitate a full range of actions, including mode changing actions and GUI actions. For example, in some embodiments, the processing system 110 operates the sensing element(s) of the input device 100 to produce electrical signals indicative of input (or lack of input) in the sensing region 120. The processing system 110 may perform any appropriate amount of processing on the electrical signals in producing the information provided to the electronic system. For example, the processing system 110 may digitize analog electrical signals obtained from the sensor electrodes. As another example, the processing system 110 may perform filtering or other signal conditioning. As yet another example, the processing system 110 may subtract or otherwise account for a baseline, such that the information reflects a difference between the electrical signals and the baseline. As yet further examples, the processing system 110 may determine positional information, recognize inputs as commands, recognize handwriting, and the like.

“Positional information” as used herein broadly encompasses absolute position, relative position, velocity, acceleration, and other types of spatial information. Exemplary “zero-dimensional” positional information includes near/far or contact/no contact information. Exemplary “one-dimensional” positional information includes positions along an axis. Exemplary “two-dimensional” positional information includes motions in a plane. Exemplary “three-dimensional” positional information includes instantaneous or average velocities in space. Further examples include other representations of spatial information. Historical data regarding one or more types of positional information may also be determined and/or stored, including, for example, historical data that tracks position, motion, or instantaneous velocity over time.

In some embodiments, the input device 100 is implemented with additional input components that are operated by the processing system 110 or by some other processing system. These additional input components may provide redundant functionality for input in the sensing region 120, or some other functionality. FIG. 1 shows buttons 130 near the sensing region 120 that can be used to facilitate selection of items using the input device 100. Other types of additional input components include sliders, balls, wheels, switches, and the like. Conversely, in some embodiments, the input device 100 may be implemented with no other input components.

In some embodiments, the input device 100 comprises a touch screen interface, and the sensing region 120 overlaps at least part of an active area of a display screen. For example, the input device 100 may comprise substantially transparent sensor electrodes overlaying the display screen and provide a touch screen interface for the associated electronic system. The display screen may be any type of dynamic display capable of displaying a visual interface to a user, and may include any type of light emitting diode (LED), organic LED (OLED), cathode ray tube (CRT), liquid crystal display (LCD), plasma, electroluminescence (EL), or other display technology. The input device 100 and the display device may share physical elements. For example, some embodiments may utilize some of the same electrical components for displaying and sensing. As another example, the display device may be operated in part or in total by the processing system 110.

It should be understood that while many embodiments of the present technology are described in the context of a fully functioning apparatus, the mechanisms of the present technology are capable of being distributed as a program product (e.g., software) in a variety of forms. For example, the mechanisms of the present technology may be implemented and distributed as a software program on information bearing media that are readable by electronic processors (e.g., non-transitory computer-readable and/or recordable/writable information bearing media readable by the processing system 110). Additionally, the embodiments of the present technology apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

In many embodiments, the positional information of the input object 140 relative to the sensing region 120 is monitored or sensed by use of one or more sensing elements (shown as sensing elements 200 in FIG. 2) that are positioned in a sensing pattern to detect its “positional information.” In general, the sensing elements may comprise one or more sensing elements or components that are used to detect the presence of an input object. As discussed above, the one or more sensing elements of the input device 100 may use capacitive, elastive, resistive, inductive, magnetic acoustic, ultrasonic, and/or optical techniques to sense the positional information of an input object. While the information presented below primarily discuses the operation of an input device 100, which uses capacitive sensing techniques to monitor or determine the positional information of an input object 140 this configuration is not intended to be limiting as to the scope of the invention described herein, since other sensing techniques may be used.

In some resistive implementations of the input device 100, a flexible and conductive first layer is separated by one or more spacer elements from a conductive second layer. During operation, one or more voltage gradients are created across the layers. Pressing the flexible first layer may deflect it sufficiently to create electrical contact between the layers, resulting in voltage outputs reflective of the point(s) of contact between the layers. These voltage outputs may be used to determine positional information.

In some inductive implementations of the input device 100, one or more sensing elements pick up loop currents induced by a resonating coil or pair of coils. Some combination of the magnitude, phase, and frequency of the currents may then be used to determine positional information.

In some capacitive implementations of the input device 100, voltage or current is applied to one or more capacitive sensing elements to create an electric field between an electrode and ground. Nearby input objects 140 cause changes in the electric field, and produce detectable changes in capacitive coupling that may be detected as changes in voltage, current, or the like. Some capacitive implementations utilize arrays or other regular or irregular patterns of capacitive sensing elements to create electric fields. In some capacitive implementations, separate sensing elements may be ohmically shorted together to form larger sensor electrodes. Some capacitive implementations utilize resistive sheets, which may be uniformly resistive.

Some capacitive implementations utilize “self capacitance” (or “absolute capacitance”) sensing methods based on changes in the capacitive coupling between sensor electrodes and an input object. In various embodiments, an input object near the sensor electrodes alters the electric field near the sensor electrodes, thus changing the measured capacitive coupling. In one implementation, an absolute capacitance sensing method operates by modulating sensor electrodes with respect to a reference voltage (e.g., system ground), and by detecting the capacitive coupling between the sensor electrodes and input objects.

Some capacitive implementations utilize “mutual capacitance” (or “transcapacitance”) sensing methods based on changes in the capacitive coupling between sensor electrodes. In various embodiments, an input object near the sensor electrodes alters the electric field between the sensor electrodes, thus changing the measured capacitive coupling. In one implementation, a transcapacitive sensing method operates by detecting the capacitive coupling between one or more transmitter sensor electrodes (also “transmitter electrodes” or “transmitters”) and one or more receiver sensor electrodes (also “receiver electrodes” or “receivers”). Transmitter sensor electrodes may be modulated relative to a reference voltage (e.g., system ground) to transmit transmitter signals. Receiver sensor electrodes may be held substantially constant relative to the reference voltage to facilitate receipt of resulting signals. A resulting signal may comprise effect(s) corresponding to one or more transmitter signals, and/or to one or more sources of environmental interference (e.g., other electromagnetic signals). Sensor electrodes may be dedicated transmitters or receivers, or may be configured to both transmit and receive. In some implementations user input from an actively modulated device (e.g. an active pen) may act as a transmitter such that each of the sensor electrodes act as a receiver to determine the position of the actively modulated device.

FIG. 2 illustrates a system for communicating between an electronic system 150 and an input device 100 that performs proximity sensing by driving a ground plane, according to one embodiment disclosed herein. The input device 100, in one embodiment, may be configured to provide input to an electronic system 150, as well as receive and process display data transmitted from the electronic system 150. The input device 100 includes the processing system 110 and sensing elements 200 associated with the sensing region 120.

In one embodiment, the processing system 110 is configured to operate the hardware of the input device 100 to detect input in the sensing region—e.g., some portion of the display screen 112. The processing system 110 comprises parts of or all of one or more integrated circuits (ICs) and/or other circuitry components. In the embodiment shown, the processing system 110 includes at least a driver module 202, a receiver module 208, and a determination module 206.

In some conventional multi-touch sensing sensor devices, in which the location of more than one finger or other input can be accurately determined, the sensing elements 200 may comprise a matrix of transmitter sensor electrodes and receiver sensor electrodes. Conventionally, during operation, capacitive images are formed by measuring the capacitance formed between each transmitter and receiver sensor electrode (referred to as “transcapacitance” or “mutual capacitance”), forming a matrix or grid of capacitive detecting elements across the sensing region 120. The presence of an input object (such as a finger or other object) at or near an intersection between transmitter and receiver sensor electrodes changes the measured “transcapacitance.” These changes are localized to the location of object, where each transcapacitive measurement is a pixel of a “capacitive image” and multiple transcapacitive measurements can be utilized to form a capacitive image of the object.

According to one embodiment, the sensing elements 200 may include the transmitting and receiving sensor electrodes disposed in a single common layer with one another without the use of jumpers within the sensor area. The reduced number of layers used to form the input device described herein versus other conventional position sensing devices also equates to fewer production steps, which in itself will reduce the production cost of the device. The reduction in the layers of the input device also decreases interference or obscuration of an image or display that is viewed through the sensor, thus lending itself to improved optical quality of the formed input device when it is integrated with a display device. Additional electrodes involved in sensing the shape of the electric fields of the transmitters and receivers, such as floating electrodes or shielding electrodes, may be included in the device and may be placed on other substrates or layers. The sensor electrodes may be part of a display (share a substrate) and may even share functionality with the display (used for both display and sensing functionality). For example sensor electrodes may be patterned in the Color filter of an LCD (Liquid Crystal Display) or on the sealing layer of an OLED (Organic Light Emitting Diode) display. Alternately, sensing electrodes within the display or on TFT (Thin Film Transistor) layer of an active matrix display may also be used as gate or source drivers. Such electrodes may be patterned (e.g. spaced or oriented at an angle relative to the pixels) such that they minimize any visual artifacts. Furthermore, they may use hiding layers (e.g. Black Mask between pixels) to hide at least some portion of one or more conductive electrodes.

FIG. 3 shows a portion of an exemplary pattern of sensing elements 200 disposed on one substrate and configured to sense in a sensing region 120 associated with the pattern. In one embodiment, the sensing elements 200 include an array 300 of sensor electrodes disposed on a first substrate 320 and a proximity sensor electrode 310. In the embodiment depicted in FIG. 3, the array 300 of sensor electrodes are illustratively shown as simple rectangles for purposes of illustration, while it is understood that the array of sensor electrodes may have other geometric forms, including lines and wire mesh.

In one embodiment, as illustrated in FIG. 3, the array 300 of sensor electrodes may comprise a plurality of transmitter electrodes 302 and a plurality of receiver electrodes 304, 306 that are formed in a single layer on a surface of a substrate 320. Sensor electrodes 302, 304, and 306 are typically ohmically isolated from each other, by use of insulating materials or a physical gap formed between the electrodes to prevent them from electrically shorting to each other. In one configuration of the input device 100, each of the transmitter electrodes 302 may be disposed proximate to one or more receiver electrodes 304, 306. In one example, a transcapacitive sensing method using the single layer sensor electrode design, may operate by detecting the change in capacitive coupling between one or more of the driven transmitter sensor electrodes and one or more of the receiver electrodes, as similarly discussed above. In such embodiments, the transmitter and receiver electrodes may be disposed in such a way such that jumpers and/or extra layers used to maintain electrical isolation between electrodes are not required. In various embodiments, the array 300 of transmitter electrodes and receiver electrodes may be formed on the surface of a substrate 320 by first forming a blanket conductive layer on the surface of the substrate 320 and then performing an etching and/or patterning process (e.g., lithography and wet etch, laser ablation, etc.) that ohmically isolates each of the transmitter electrodes and receiver electrodes from each other. In other embodiments, the sensor electrodes may be patterned using deposition and screen printing methods. As illustrated in FIG. 3, the array 300 of sensor electrodes may be disposed in a manner that forms a rectangular pattern of sensing elements, which may comprise one or more transmitter electrodes and one or more receiver electrodes. In one example, the blanket conductive layer used to form the transmitter electrodes and receiver electrodes comprises a thin metal layer (e.g., copper, aluminum, etc.) or a thin transparent conductive oxide layer (e.g., ATO, ITO, Zinc oxide) that may be deposited using convention deposition techniques known in the art (e.g., PVD, CVD, and the like). In various embodiments, patterned isolated conductive electrodes (e.g., electrically floating electrodes) may be used to improve visual appearance. In one or more of the embodiments described herein, the sensor electrodes are formed from a material that is substantially optically clear, and thus, in some configurations, can be disposed between a display device and the input device user.

The areas of localized capacitive coupling formed between at least a portion of one or more transmitter electrodes 302 and at least a portion of one or more receiver electrodes 304, 306 may be termed a “capacitive pixel,” or also referred to herein as a sensing element. For example, as shown in FIG. 3, the capacitive coupling in a sensing element may be created by the electric field formed between at least a portion of the transmitter electrode 302 and a receiver electrode 304, which changes as the proximity and motion of input objects across the sensing region changes.

In some embodiments, the sensing elements are “scanned” to determine these capacitive couplings. The input device 100 may be operated such that one transmitter electrode transmits at one time, or multiple transmitter electrodes transmit at the same time. Where multiple transmitter electrodes transmit simultaneously, these multiple transmitter electrodes may transmit the same transmitter signal and effectively produce an effectively larger transmitter electrode, or these multiple transmitter electrodes may transmit different transmitter signals. For example, in one configuration, multiple transmitter electrodes 302 transmit different transmitter signals according to one or more coding schemes that enable their combined effects on the resulting signals received by the receiver electrodes 304 or 306 to be independently determined. The direct effect of a user input which is coupled to the device may affect (e.g. reduce the fringing coupling) of the resulting signals. Alternately, a floating electrode may be coupled to the input and to the transmitter and receiver and the user input may lower its impedance to system ground and thus reduce the resulting signals. In a further example, a floating electrode may be displaced toward the transmitter and receiver which increases their relative coupling. The receiver electrodes, or a corresponding sensor electrode 304, may be operated singly or multiply to acquire resulting signals created from the transmitter signal. The resulting signals may be used to determine measurements of the capacitive couplings at the capacitive pixels, which are used to determine whether an input object is present and its positional information, as discussed above. A set of values for the capacitive pixels form a “capacitive image” (also “capacitive frame” or “sensing image”) representative of the capacitive couplings at the pixels. In various embodiments, the sensing image, or capacitive image, comprises data received during a process of measuring the resulting signals received with at least a portion of the sensing elements distributed across the sensing region 120. The resulting signals may be received at one instant in time, or by scanning the rows and/or columns of sensing elements distributed across the sensing region 120 in a raster scanning pattern (e.g., serially polling each sensing element separately in a desired scanning pattern), row-by-row scanning pattern, column-by-column scanning pattern or other useful scanning technique. In many embodiments, the rate that the “sensing image” is acquired by the input device 100, or sensing frame rate, is between about 60 and about 180 Hertz (Hz), but can be higher or lower depending on the desired application.

In some touch screen embodiments, a portion or all of the array 300 of sensor electrodes is disposed on a substrate of an associated display device. For example, the sensor electrodes 302 and/or the sensor electrodes 304 may be disposed on the substrate 320, which may be one of a polarizer, a color filter substrate, or a glass sheet of an LCD. As a specific example, the substrate 320 having the sensor electrodes 302, 304, and 306 disposed thereon, may be a TFT (Thin Film Transistor) substrate of an LCD type of the display device, a color filter substrate, on a protection material disposed over the LCD glass sheet, on a lens glass (or window), and the like. The sensor electrodes may be separate from and in addition to the display electrodes, or shared in functionality with the display electrodes. In some touchpad embodiments, the sensing elements 200 are disposed on a substrate of a touchpad. In such an embodiment, the sensor electrodes in each sensing element and/or the substrate may be substantially opaque. In some embodiments, the substrate and/or the sensor electrodes of the sensing elements may comprise a substantially transparent material.

In those embodiments, where sensor electrodes of each of the sensing elements are disposed on a substrate within the display device (e.g., color filter glass, TFT glass, etc.), the sensor electrodes may be comprised of a substantially transparent material (e.g., ATO, ClearOhm™) or they may be comprised of an opaque material and aligned with the pixels of the display device. Electrodes may be considered substantially transparent in a display device if their reflection (and/or absorption) of light impinging on the display is such that human visual acuity is not disturbed by their presence. This may be achieved by matching indexes of refraction, making opaque lines narrower, reducing fill percentage or making the percentage of material more uniform, reducing spatial patterns (e.g. moire’) that are with human visible perception, and the like.

In one embodiment, the array 300 of sensor electrodes includes a ground plane 308 disposed on the same substrate 320 as the sensor electrodes (e.g., sensor electrodes 302, 304, and 306). The ground plane 308 may be a contiguous region of conductive material, such as a shield or grounded electrode, disposed between, but not touching, the sensor electrodes. As depicted in a fine hatch in FIG. 3, the ground plane 308 may be a grounded electrode that substantially “fills” the surface area in between columns of sensor electrodes disposed on the substrate 320. While some embodiments of a sensor have a significant portion occupied by the ground plane 308 in order to reduce adverse effects of “low ground mass,” it has been determined that the area of the ground plane 308 may be “re-used” for proximity sensing. According to one embodiment of the present invention, the ground plane 308 may be driven with a sensing signal to perform proximity sensing in relation to the input device 100.

In one embodiment, the proximity sensor electrode 310 is configured to sense input (or lack thereof) in a proximity sensing region 322 between the proximity sensor electrode 310 and the array 300 of sensor electrodes, including the ground plane 308, the transmitter electrodes 302, and the receiver electrode 304, 306. The proximity sensor electrode 310 may be disposed parallel to and adjacent to the array 300 of sensor electrodes. In the embodiment shown, the proximity sensor electrode 310 extends along at least one edge of the array 300 of sensor electrodes and the ground plane 308. In one embodiment, the ground plane 308 and the array 300 of sensor electrodes overlay an active area of a display screen, and the proximity sensor electrode 310 overlays a non-active area of the display screen.

Referring back to FIG. 2, the driver module 202 may include driver circuitry 204 coupled to the transmitter electrodes 302 and to the ground plane 308 and configured to drive the hardware components for capacitive sensing, display updating, and interference measurement. In one embodiment, the driver module 202 is configured to operate in a first mode to drive the transmitter electrodes 302 (e.g., via transmitter channels Tx0, Tx1, Tx2, Tx3) with one or more transmitter signals for capacitive sensing, while driving the ground plane 308 to a ground voltage (e.g., via transmitter channel Tx4). The driver module 202 is further configured to operate in a second mode to drive the ground plane 308 with a sensing signal for performing proximity sensing in a second sensing region, i.e., proximity sensing region 322. In some embodiments, the driver module 202 may be configured to drive the ground plane 308 in addition to one or more transmitter electrodes 302, the ground plane 308 and transmitter electrodes having a total effective transmitter area for performing proximity sensing in the proximity sensing region 322.

In one embodiment, the receiver module 208 having receiver circuitry 212 is coupled to the plurality of receiver electrodes (e.g., electrodes 304, 306) and to the proximity sensor electrode 310. The receiver module 208 is configured to receive resulting signals from the plurality of receiver electrodes 304 (e.g., via receiver channels Rx0, Rx2, Rx4, Rx6) and receiver electrodes 306 (e.g., via receiver channels Rx1, Rx3, Rx5, Rx7) when performing capacitive sensing within the sensing region 120. The receiver module 208 is further configured to receive resulting signals from the proximity sensor electrode 310 (e.g., via a receiver channel Rx8) when detecting object presence in the proximity sensing region 322.

In one embodiment, the determination module 206 is configured to determine positional information based on resulting signals. In some embodiments, the determination module 206 may be configured to operate in a first mode to generate an indication of object presence in the sensing region 120 based on resulting signals received by receiver electrodes 304, 306. In some embodiments, the determination module 206 may be configured to operate in a second mode to generate an indication of object presence in a proximity sensing region 322. Accordingly, embodiments of the invention enable an input device to be configured with proximity region(s) of a particular shape and/or arrangement in anticipation of particular objects, such as a human face.

FIG. 4 is a flow diagram illustrating a method for operating an input device in an input mode and a proximity mode, according to one embodiment of the invention. The input device 100 is configured to operate in a first mode (i.e., an input mode 410) for sensing an input object 140 in the active sensing region 120 of the input device 100. The input device 100 is further configured to operate in a second mode (i.e., proximity mode 420) for sensing objects in the proximity sensing region 322.

In the embodiment shown, the input device 100 may begin operation in the input mode 410 where, at step 402, the processing system 110 of the input device drives a sensing signal on one or more transmitter sensor electrodes 302 of the array 300 of sensor electrodes. At step 404, the processing system 110 drives the ground plane 308 at a ground voltage (e.g., a constant 0V). In some embodiments, the processing system 110 may drive a constant 0V, effectively connecting the ground plane 308 to a ground of driver circuitry 204, for example, through transmitter transistors of the driver circuitry 204. At step 406, the processing system 110 receives a resulting signal from at least one of the receiver electrodes 304, 306 of the array 300 of sensor electrodes. At step 408, the processing system 110 generates an indication of an object presence in a first sensing region (i.e., sensing region 120) based on the resulting signal.

According to one embodiment, the input device 100 may switch operation to the proximity mode 420 wherein the input device uses the ground plane 308 in conjunction with the proximity sensor electrode 310 to perform transcapacitive sensing for determining object presence in the proximity sensing region 322. At step 422, the processing system 110 of the input device drives a sensing signal on at least a portion the ground plane 308 (e.g., via transmitter channel Tx4). The processing system 110 may concurrently drive a sensing signal on one or more transmitter electrodes 302 for additional transmitter area. By selecting the ground plane 308 in addition to one or more transmitter electrodes 302 to be driven with a sensing signal, the processing system 110 may increase the effective transmitter area used in proximity sensing than might otherwise be available in a single layer pattern of sensor electrodes. The increased transmitter area advantageously results in increased resulting signals received on the proximity sensor electrode 310. The number of transmitter electrodes 302 driven, and in which order, may be configured as part of a proximity sensing tuning process or other operation, for example, as described in conjunction with FIG. 5.

At step 424, the processing system 110 receives a resulting signal from the proximity sensor electrode 310. The resulting signal may be processed to determine an indication of the presence of an input object in the proximity sensing region 322. At step 426, the processing system 110 generates an indication of object presence in the proximity sensing region 322, i.e., in a second sensing region different than the first sensing region 120.

At step 428, responsive to detection of an input object 140 in the proximity sensing region 322 while operating in the proximity mode 420, operation of the input device 100 may be modified. For example, modification of the operation of the input device 100 may include modifying an indication of object presence in the active sensing region 120, during operation in the input mode 410, in response to an indication of object presence in the proximity sensing region 322 when operating in the proximity mode 420. For example, in response to detecting object presence in the proximity sensing region 322, which may represent a cheek or other unintentional input object, the input device may suppress or disregard object presence in the active sensing region 120. In another example, the input device 100, at step 428, may modify indications of object presence in the active sensing region 120.

FIG. 5 depicts a schematic side view of the sensing elements 200 disposed on the substrate 320 of FIG. 3, according to one embodiment of the present invention. As shown, the sensing elements 200 includes a first group of transmitter electrodes 302 coupled to the processing system via the first transmitter channel Tx0 and disposed at a distance A from the proximity sensor electrode 310, a second group of transmitter electrodes (i.e., Tx1) disposed at a distance B from the proximity sensor electrode 310, a third group of transmitter electrodes (i.e., Tx2) disposed at a distance C from the proximity sensor electrode 310, and a fourth group of transmitter electrodes (i.e., Tx3) disposed at a distance D from the proximity sensor electrode 310. The ground plane 308 is omitted for clarity of illustration. In one embodiment, the transmitter electrodes 302 of the sensing elements 200 may be driven, in conjunction with the ground plane 308, based on their corresponding distance (e.g., A, B, C, D) from proximity sensor electrode 310 to sense object presence at a corresponding height (e.g., a, b, c, d) from the plane of the transmitter electrodes 302.

According to one embodiment, the processing system 110 may drive the ground plane 308 and one or more transmitter electrodes 302 according to a variety of drive patterns to achieve sensitivity at different heights relative to the input device 100. In one drive pattern, all groups of transmitter electrodes 302 and the ground plane 308 may be driven in-phase together to generate a higher signal than each group of transmitter electrodes would generate independently. In a second drive pattern, each group of transmitter electrodes may be driven independently, in conjunction with the ground plane 308. For example, the first group of transmitter electrodes (i.e., Tx0) may be selectively driven with the ground plane 308 to achieve proximity sensing at a distance “a” from the plane of the transmitter electrodes. In another drive pattern, one or more groups of transmitter electrodes (e.g., Tx0 and Tx1) may be driven in-phase together, in conjunction with the ground plane 308, to generate a signal that is greater than a signal each group of transmitter electrodes (e.g., Tx0 or Tx1) would generate independently, and less than a signal generated by all groups of transmitter electrodes driven together. It has been determined that such a drive scheme provide a beneficial trade-off between signal level generated and a granularity of the distance measurement.

According to one embodiment, the processing system 110 may combine multiple drive patterns to take advantage of the relative signal strengths of each group of transmitter electrodes. In some embodiments, the processing system 110 may be configured to combine multiple drive patterns based on a total effective transmitter area of the driven transmitter electrodes and ground plane. In one implementation, when operating in the proximity mode 420, the driver module 202 of the processing system 110 may drive a single group of transmitter electrodes, then two groups of transmitter electrodes, then three groups of transmitter electrodes, and so forth with sets of more groups of transmitter electrodes that are grouped together to achieve a higher resulting signal. For example, when operating in the proximity mode 420, the driver module 202 may drive the first group of transmitter electrodes (i.e., Tx0) by itself to give a highest granularity. The driver module 202 may further drive the second and third groups of transmitter electrodes (i.e., Tx1 and Tx2) together in conjunction with the ground plane 308, because these groups are at a distance B and C further away from the proximity sensor electrode 310 than the distance A associated with Tx0 and may otherwise have a lower individual signal. The driver module 202 may then drive fourth, fifth, and sixth groups of transmitter electrodes (i.e., Tx3, Tx4, and Tx5) driven together, in conjunction with the ground plane 308, to give a much higher signal than otherwise obtained individually.

While the foregoing is directed to embodiments of the present invention, other and further embodiments of the invention may be devised without departing from the basic scope thereof, and the scope thereof is determined by the claims that follow.

1. An input device, comprising:
a ground plane disposed on a first surface of a substrate;
an array of capacitive sensor electrodes disposed within the ground plane on the first surface of the substrate and configured to sense input objects in a first sensing region;
a proximity sensor electrode configured to sense input objects in a second sensing region; and
a processing system communicatively coupled to the array of capacitive sensor electrodes, the proximity sensor electrode, and the ground plane, and configured to operate in a first mode and a second mode, wherein operating in the first mode comprises:
receiving a sensing resulting signal produced between a first set of sensor electrodes of the array of capacitive sensor electrodes and a second set of sensor electrodes of the array of capacitive sensor electrodes; and
generating an indication of object presence in the first sensing region based on the sensing resulting signal; and
wherein operating in the second mode comprises:
receiving a first resulting proximity signal produced between the proximity sensor electrode and the ground plane; and
generating an indication of object presence in the second sensing region based on the first resulting proximity signal.

2. The input device of claim 1, wherein the processing system is configured to operate in the second mode further comprising:
driving the ground plane while receiving the first resulting proximity signal on the proximity sensor electrode.

3. The input device of claim 1, wherein the processing system is configured to operate in the first mode further comprising:
driving the ground plane at a ground voltage while receiving the sensing resulting signal.

4. The input device of claim 1, wherein the processing system is configured to operate in the first mode further comprising:
driving the ground plane at a reference voltage while receiving the sensing resulting signal.

5. The input device of claim 1, wherein the processing system is configured to operate in the first mode further comprising:
driving the ground plane at a varying voltage while receiving the sensing resulting signal.

6. The input device of claim 1, wherein a receiver is communicatively coupled to the ground plane, and wherein the processing system is configured to operate in the second mode further comprising:
driving the proximity sensor electrode while receiving the first resulting proximity signal using the ground plane.

7. The input device of claim 1, wherein the processing system is configured to operate in the second mode further comprising:
receiving a second resulting proximity signal produced between the proximity sensor electrode and a third set of sensor electrodes of the array of capacitive sensing electrodes; and
generating an indication of an object presence in a third sensing region based on the second resulting proximity signal.

8. The input device of claim 7, wherein the distance between the proximity sensor electrode and the third set of sensor electrodes is greater than the distance between the proximity sensor electrode and the first set of sensor electrodes.

9. The input device of claim 7, wherein a total surface area of the third set of sensor electrodes is greater than a total surface area of the first set of sensor electrodes.

10. The input device of claim 7, wherein the third sensing region is configured to detect input objects at a greater distance from a surface of the input device than the second sensing region.

11. The input device of claim 7, wherein the first set of sensor electrodes and the third set of sensor electrodes are drive in-phase.

12. The input device of claim 1, wherein the ground plane and the array of capacitive sensor electrodes overlay an active area of a display screen, and the proximity sensor electrode overlays a non-active area of the display screen.

13. A processing system for an input device, the processing system comprising:
sensor circuitry configured to be communicatively coupled to a proximity sensor electrode, a ground plane, and an array of capacitive sensor electrodes, wherein the ground plane and the array of capacitive sensor electrodes are disposed on a first surface of a substrate; and
control logic configured to operate the input device in a first mode comprising:
receiving a sensing resulting signal produced between a first set of sensor electrodes of the array of capacitive sensor electrodes and a second set of sensor electrodes of the array of capacitive sensor electrodes; and
generating an indication of object presence in a sensing region based on the sensing resulting signal; and
wherein the control logic is configured to operate the input device in a second mode comprising:
receiving a first resulting proximity signal produced between the proximity sensor electrode and the ground plane; and
generating an indication of object presence in a second sensing region based on the first resulting proximity signal.

14. The processing system of claim 13, wherein the control logic configured to operate in the second mode further comprises:
driving the ground plane while receiving the first resulting proximity signal on the proximity sensor electrode.

15. The processing system of claim 13, wherein the control logic configured to operate in the first mode further comprises:
driving the ground plane at a ground voltage while receiving the sensing resulting signal.

16. The processing system of claim 13, wherein the control logic configured to operate in the second mode further comprises:
driving the proximity sensor electrode while receiving the first resulting proximity signal using the ground plane.

17. The processing system of claim 13, wherein the control logic configured to operate in the second mode further comprises:
receiving a second resulting proximity signal produced between the proximity sensor electrode and a third set of sensor electrodes of the array of capacitive sensing electrodes; and
generating an indication of an object presence in a third sensing region based on the second resulting proximity signal.

18. The processing system of claim 17, wherein a total surface area of the third set of sensor electrodes is greater than a total surface area of the first set of sensor electrodes.

19. The processing system of claim 17, wherein the third sensing region is configured to detect input objects at a greater distance from a surface of the input device than the second sensing region.

20. The processing system of claim 13, wherein the ground plane and the array of capacitive sensor electrodes overlay an active area of a display screen, and the proximity sensor electrode overlays a non-active area of the display screen.
